(19) United States
(12) Patent Application Publication
(10) Pub. No.: US 2005/0122439 A1
(43) Pub. Date: Jun. 9, 2005

(54) Acoustic frame for flat screen television

(76) Inventor: Darwin Chang, Cupertino, CA (US)

Correspondence Address: MARVIN H. KLEINBERG;Kleinberg & Lerner, LLP, Suite 1080, 2049 Century Park East, Los Angeles, CA, 90067-3112, US

(21) Appl. No.: 10/974,452

(22) Filed: Oct. 24, 2004

Related U.S. Application Data
(60) Provisional application No. 60/513,649, filed on Oct. 23, 2003.

(51) Int. Cl. H04N 15/00

(52) U.S. Cl. 348/834; 348/825

(57) ABSTRACT

An acoustic frame for use in connection with a flat-screen television includes an acoustic matte, the acoustic matte being substantially transparent to sound waves and infra-red radiation, wherein the acoustic matte is arranged so as to surround a display screen on the flat-screen television, an interchangeable art frame coupled to, and overlapping, an outer periphery of the acoustic matte, a positioning apparatus coupled to a rear surface of the acoustic matte for positioning the acoustic frame in relation to the flat-screen television, and apparatus for attaching the acoustic frame to the flat-screen television disposed on the rear surface of the acoustic matte.

The present application is a continuation-in-part of application Ser. No. 60/513,649, filed Oct. 23, 2004.

### BACKGROUND

1. Field of the Invention

The present invention relates to enhancement of display devices, and more particularly to enhancing the periphery of flat screen televisions and monitors through the use of an acoustic frame.

2. Prior Art

The development and proliferation of flat screen televisions and computer monitors has led to their being hung on walls, hung on ceilings, placed on desks, and placed in other ways in which framed pictures and art are placed. In all of these varying ways of placement, the display device lacks any means for attaching devices such as speakers, antennas, infrared ports, and other items in such a way that they are hidden from view.

While prior art such as U.S. Pat. No. 5,638,096 discloses a decorative border for a display device and U.S. Pat. No. 6,550,172 discloses a border for a display device where the border contains chambers for storage and other functions, neither of these prior art devices incorporate into a single border the ability to attach conventional art frames to the border or the ability to be acoustically transparent nor transparent to light and particularly infrared light used by remote controls. Nordo either of these devices provide for attaching speakers, antennas, or infrared ports to, or within, the acoustic frame.

In light of the foregoing shortcomings of the prior art, a frame is needed for display devices where the frame can accommodate practically any combination of aesthetic and functional features.

The acoustic frame disclosed herein provides a number of means by which these items may be attached to the acoustic frame and a number of other means by which the acoustic frame itself may be attached to the display device. A conventional art frame may also be attached to the periphery of the acoustic frame.

### BRIEF SUMMARY OF THE INVENTION

An acoustic frame for use in connection with a flat-screen television includes an acoustic matte, the acoustic matte being substantially transparent to sound waves and infra-red radiation, wherein the acoustic matte is arranged so as to surround a display screen on the flat-screen television, an interchangeable art frame coupled to, and overlapping, an outer periphery of the acoustic matte, a positioning apparatus coupled to a rear surface of the acoustic matte for positioning the acoustic frame in relation to the flat-screen television, and apparatus for attaching the acoustic frame to the flat-screen television disposed on the rear surface of the acoustic matte.

### BRIEF DESCRIPTION OF THE DRAWINGS

FIG. 1 is a perspective view of the acoustic frame attached to a display device.

FIG. 2 is a cross-sectional view of the acoustic frame attached to a display device, taken along the line 2-2 in FIG. 1.

FIG. 3 illustrates different arrangements for connecting the acoustic matte to the interchangeable art frame.

FIG. 4 is a perspective view of the acoustic frame showing a door in the acoustic matte to allow access to the display device.

FIG. 5 is a rear view of the acoustic frame attached to a display device.

### DETAILED DESCRIPTION OF THE INVENTION

An acoustic frame for flat-screen display devices will be described. In the following description, specific components and circuitry are described in detail to give a more thorough understanding of the present invention. In other instances, well-known components are not described in detail so as to not obscure the present invention unnecessarily.

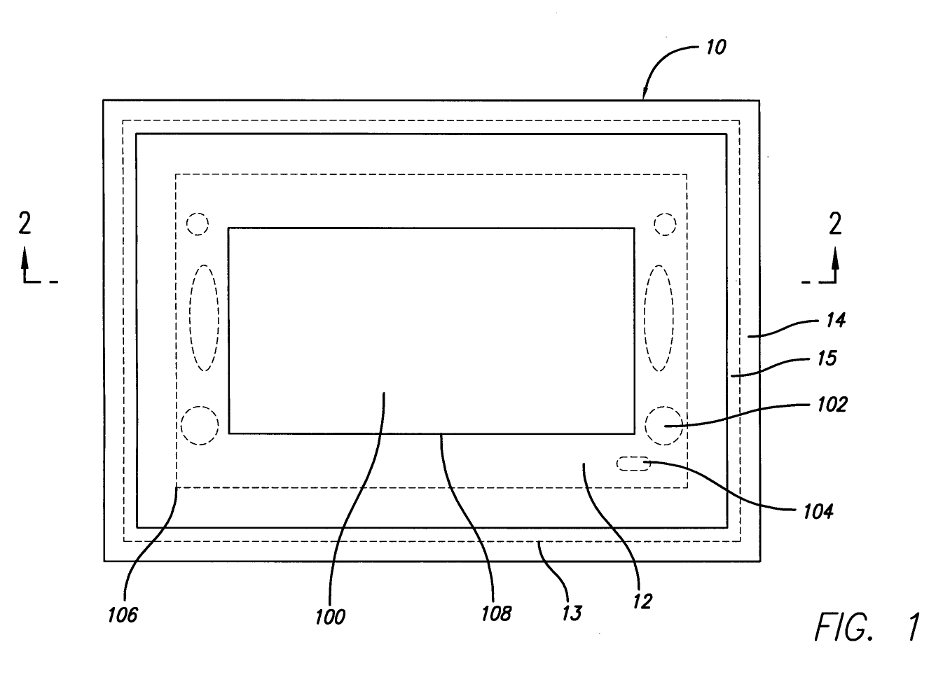

Referring first to FIG. 1, a perspective view of the preferred embodiment of the acoustic frame 10 is shown. In FIG. 1, the acoustic frame is illustrated as being attached to a display device 100. The major components of the preferred embodiment of the acoustic frame 10 consist of an acoustic matte 12 attached to an interchangeable art frame 14. In the preferred embodiment of the present invention, the display device is a flat-screen television, such as plasma or LCD television. The acoustic frame 10 includes a suitable means for attaching to the display device 100. The attachment means is not shown in FIG. 1, and is described below. It is to be understood that the display device is not part of the invention itself. The acoustic frame 10 is used in conjunction with the display device. Moreover, the display device is not limited to only a flat-screen television. The acoustic frame 10 can be used to enhance the use of a wide range of similar devices, such as computer monitors, rear screen projection televisions, or the like. As used in this description, the term “display device” will be understood to include virtually any type of device that is used to display images on a screen, including flat screen televisions, CRT televisions, computer monitors, rear screen projection televisions, or the like.

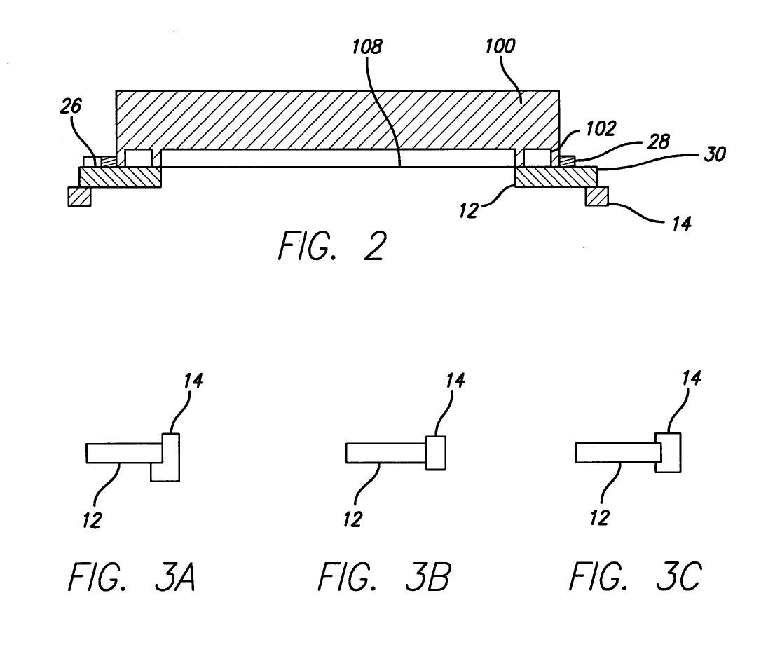

Referring again to FIG. 1, the acoustic matte 12 is positioned along the inner border 15 of the art frame 14. The acoustic matte 12 and the art frame 14 are fixed together using any suitable means known in the art. However, the two components may be separated. Referring now to FIG. 2, the acoustic matte 12 is shown as being substantially flush with the front surface of the display device 100. In the preferred embodiment, a number of clips 28 are used to hold the acoustic frame 10 on the display device 100. In addition, a ridge or stop 30 is provided to position and align the acoustic frame 10 on the display device. The clips 28 and stop 30 work together to securely hold the acoustic frame 10 to the display device 100 in the desired manner. Although the acoustic matte 12 is shown being flush with the screen 108 in FIG. 2, it will be apparent to the art that an exact registration is not required, and that there may be a small gap between the two, without affecting the operation of the invention.

The clips 28 holds the acoustic matte 12 in such a manner that the matte is substantially parallel to the front of the display device 100, with the opening framed by the acoustic matte substantially matching the display device screen 108. In the preferred embodiment, the attachment means comprises clasps, aligned by positioning means, a ridge on the acoustic matte. The interchangeable art frame 14 is attached flush to the acoustic matte 12 in any of a variety of orientations. FIG. 2 shows the interchangeable art frame 14 in front of the acoustic matte 12. However, the acoustic matte 12 may be attached to the art frame 14 in other ways. Some of these arrangements are illustrated in FIG. 3. FIG. 3(a) shows the interchangeable art frame 14 in front and along the side of the acoustic matte 12. FIG. 3(b) shows the interchangeable art frame 14 along the side of acoustic matte 12. FIG. 3(c) shows the interchangeable art frame 14 surrounding the outer edge of acoustic matte 12.

The acoustic matte 12 is typically made of a material that allows it to be substantially transparent to sound waves and infrared radiation. “Substantially transparent” to sound waves in the context of the present invention means that for a listener there is no discernable difference listening to the display device with or without the acoustic matte 12 in place. With respect to infrared radiation, “substantially transparent” in the context of the present invention means that the acoustic matte does not impede the functioning of the infrared transmitter on the remote control unit of the display device. Use of such materials and/or a manner of construction in the preferred embodiment allows the display device speakers to be heard when mounted behind the acoustic matte and further allows remote controls to communicate with the display device's infrared ports mounted behind or inside the acoustic matte. The acoustic matte may have the appearance of a matte such as those used within the perimeter of a conventional art frame. The acoustic matte 12 can be any color, design, or appearance that suits the desires of the user.

The interchangeable art frame 14 may be comprised of one or more pieces and have the appearance of a conventional art frame. In the preferred embodiment, the art frame 14 has the appearance of a wood frame. The art frame 14 may be manufactured from wood or any other suitable material. Of course, the art frame is not limited only the appearance of the preferred embodiment. Other styles and materials may be used with equal effectiveness. The interchangeable art frame 14 can be any color, design, or appearance that suits the desires of the user.

In the preferred embodiment, the acoustic frame 10 is rectangular in shape. The aspect ratio for the preferred embodiment matches the aspect ratio of the screen 108 of the display device 100 for which it is used. However, the acoustic frame may be any size, as it is not limited to a particular size of display device. The standard aspect ratios for televisions are 16:9 and 4:3. The present invention can be used with both aspect ratios, as well as other, non-standard, sizes.

In the preferred embodiment, the acoustic frame 10 surrounds the viewable area of display device 100, as shown in FIG. 1. However, the acoustic frame may overlap a portion of the display device's viewable area. Alternatively, the area framed by the acoustic frame may be larger than the viewable area of the display device, such that a portion of the display device itself remains visible. The matte may be designed to overlap some portion of the displayed image for a cleaner appearance. This slightly increases the amount of overscanned video up to 10-20% of NTSC without breaking rules of NTSC safe action (10%) and safe title (20%) areas.

Display devices typically have audio speakers. In FIGS. 1 and 2, the display device is a television with its speakers mounted in the front along the sides, as is typical for televisions. In the preferred embodiment, the acoustic matte 12 hides the display device's speaker elements. However, the acoustic matte is suitable to be used with display devices that use side-mounted speakers or separate speakers.

Display devices such as televisions typically have remote controls, such as infrared controls that communicate with the display device's infrared detector. In the preferred embodiment, the acoustic matte 12 hides the display device's infrared detector, as shown in FIG. 1. However, the acoustic matte is suitable to be used with display devices that do not have infrared detectors, including those that employ other means of control such as manual, hard-wired, acoustic, radio control, or any other light frequency.

The acoustic frame 10 can be attached to the display device 100 in a variety of different ways, not limited to any single method or structure. For example, attachment means includes screws, latches, clasps, glue, mushroom posts, magnets, with equal effectiveness. For a dedicated fit, the display device includes a lip, ridge, groove, or channel or the like that acts as a line of attachment or positioning for the acoustic frame or its pieces, as shown in FIG. 2.

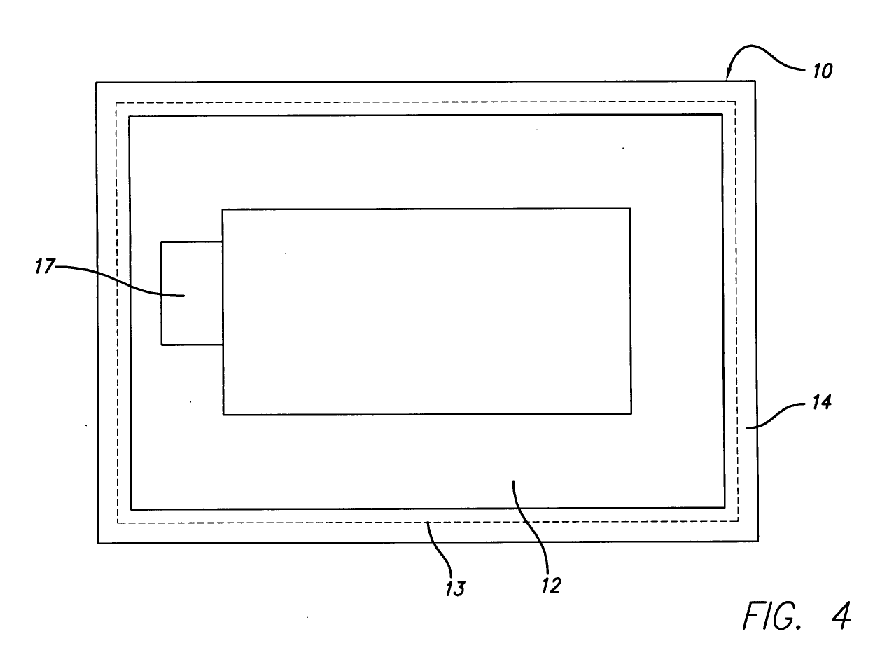

FIG. 4 shows a perspective view, without the display device pictured, of the preferred embodiment of the acoustic frame 10 with the acoustic matte 12 attached to the interchangeable art frame 14, which surrounds the visible area of the acoustic matte. FIG. 4 also shows a door 17 in the acoustic matte that allows access to components of the display device 100. FIG. 2 shows means 26 for attaching components for the display devices, such as antennas, speakers, or infrared detectors.

In the first preferred embodiment, the acoustic matte 12 is made of plastic covered with fabric. Other alternative embodiments include acoustic mattes made of wood, metal, or some other suitable lightweight material, covered in front with cloth, paper, or some other suitable material that is substantially transparent for sound waves and infrared radiation. While the substantially transparent material allows remote control through infrared radiation in the preferred embodiment, other means of control such as manual, hard-wired, acoustic, radio control, or any other light frequency are also possible.

The interchangeable art frame 14 is attached to the perimeter of the acoustic matte 12, as shown in FIG. 2. In this configuration, the interchangeable art frame can be attached in such a way so as to completely hide the acoustic matte or in such a way so as to completely or partially allow the acoustic matte to be seen within the inside perimeter of the conventional frame. FIG. 4 shows the preferred embodiment with the interchangeable front art frame 14 attached to and partially covering the acoustic matte 12.

In an alternative embodiment, the acoustic matte 12 is attached to the display device 100 without also being attached to the interchangeable art frame. Aesthetically the acoustic matte can function without the interchangeable art frame 14.

The acoustic matte 12 can be attached to the interchangeable art frame 14 in a variety of different ways not limited to any single method or structure. For example, attachment means include screws, latches, clasps, glue, mushroom posts, or magnets, with equal effectiveness. As shown in FIGS. 3(a) and 3(c), for a dedicated fit the interchangeable art frame includes a lip, ridge, groove, or channel or the like that acts as a line of attachment or positioning for the acoustic matte or its pieces.

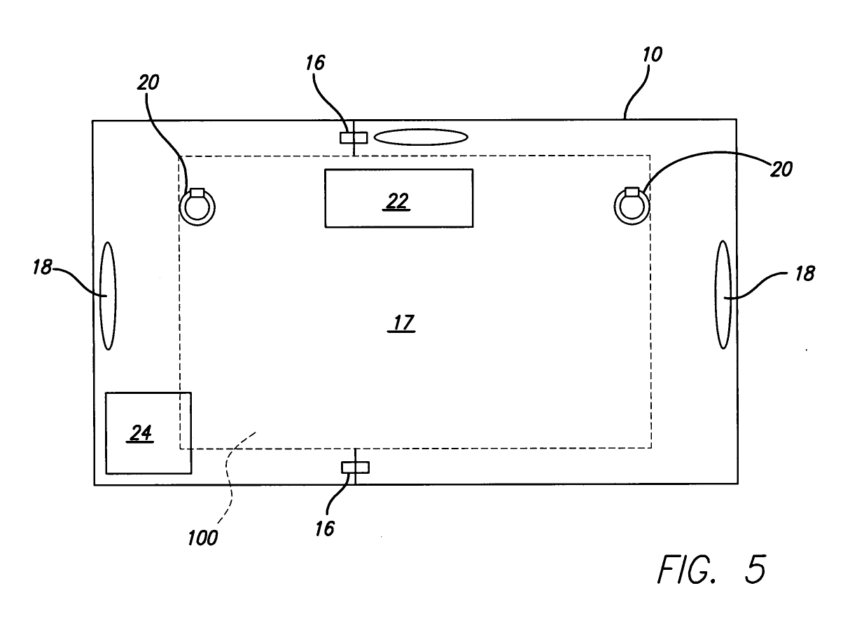

In the preferred embodiment, the acoustic frame 10 is comprised of one piece that is attached to the periphery of the display device 100. In an alternative embodiment, the acoustic frame 10 is comprised of a plurality of primary pieces that are attached to the periphery of the display device 100. When the acoustic frame 10 comprises more than one primary piece, it can be made sturdier and more stable after being attached to the display device 100 by connecting the acoustic frame pieces to one another. FIG. 5 shows the use of the alternative embodiment that has on the back surface latches 16, hooks, or other support means. Any such primary piece or pieces may have a door 17 or swing-away panel built into the primary piece so as to allow ready access to the area or components behind the acoustic frame.

FIG. 5 shows the preferred embodiment of the acoustic frame with carrying handles 18. Handles may be attached to the acoustic frame so that the combined assembly can be more easily carried or moved. FIG. 5 also shows the preferred embodiment of the acoustic frame with attachment rings 20 for security, mounting, and tip-over safety. After the acoustic frame 10 is securely attached to the display device 100, the acoustic frame can act as a point of attachment by rings, hooks, latches, screws, clasps, glue, mushroom posts, magnetism, or any attachment means, for securing the combined assembly to a wall, ceiling, desk, or other object.

As shown in FIG. 5, openings 22 in the back of the acoustic frame 10 for user connectors are located very near to the display device 100 inputs in order to improve the video quality. The acoustic frame 10 also provides openings 24 for optional modules that connect through external cables, such as DVD players.

The acoustic frame can also be made so that it supports interchangeable front bezels. This allows users to customize and personalize the appearance of the acoustic frame without changing the frame itself. A matte such as those used within the perimeter of a conventional art frame may be placed over the acoustic matte 12 if so desired by the user. Additionally, non-traditional elements, e.g., glass, may also be placed over the acoustic matte 12. In these configurations, the speakers 102 and infrared port 104 may function better if they are removed from behind the acoustic matte. It is also possible to use the acoustic frame 10 in any configuration described herein without attaching any components to it such as speakers or an infrared port. The acoustic frame 10 can bear any color, design, or appearance that suits the desires of the user.

Although the present invention has been described in detail with reference to certain preferred versions, other versions are possible. Accordingly, the spirit and scope of the invention is not defined only by the preceding description, but is limited only by the following claims.

1. An acoustic frame, comprising:
an acoustic matte;
an interchangeable art frame; and
means for attaching the acoustic frame to a display device.

2. The device of claim 1 wherein said acoustic matte is located near an inner border of said interchangeable art frame.

3. The device of claim 1, wherein said acoustic matte is substantially transparent to sound waves generated by speakers of the display device and infrared radiation received by a detector of the display device

4. The device of claim 1, wherein said acoustic matte and said art frame are manufactured as a single integrated unit.

5. The device of claim 1, further comprising a door built into the acoustic matte so as to allow access behind said acoustic matte.

6. An acoustic frame for use in connection with a flat-screen television, comprising:
an acoustic matte, said acoustic matte being substantially transparent to sound waves and substantially transparent to infra-red radiation, said acoustic matte being arranged so as to surround a display screen on the flat-screen television;
an art frame coupled to, and overlapping, an outer periphery of said acoustic matte;
positioning means coupled to a rear surface of said acoustic matte for positioning the acoustic frame in relation to the flat-screen television; and
means for attaching the acoustic frame to the flat-screen television, said means being disposed on said rear surface of said acoustic matte.

7. The device of claim 6 further comprising an anti-glare screen coupled to said acoustic matte or said art frame.

8. The device of claim 6 wherein said attachment means comprises a plurality of clips coupled to a back surface of said acoustic matte.

9. The device of claim 6 wherein said positioning means comprises at least one stop formed on a back surface of said acoustic matte.

10. The device of claim 6 wherein said acoustic matte comprises fabric stretched over a rigid material.

11. The device of claim 10 wherein said rigid material comprises plastic.

12. The device of claim 6, further comprising a door in said acoustic matte so as to allow access behind said acoustic matte.

13. The device of claim 6, further comprising a carrying handle attached to the acoustic frame.

14. The device of claim 6, wherein the acoustic frame accommodates interchangeable bezels.

15. The device of claim 6, wherein said art frame is comprised of multiple pieces coupled together.

16. The device of claim 6, wherein openings in the back of the acoustic frame for user connectors are located very near to the display device screen inputs in order to improve the video quality.

17. The device of claim 6, wherein openings in the back of the acoustic frame provide access for display device optional modules that connect through external cables, such as DVD players.

18. The device of claim 6, further comprising an anti-glare touch screen attached to the acoustic matte and covering the display device's screen.

19. The device of claim 6, further comprising means for attaching an antenna to the acoustic frame.

20. The device of claim 6, further comprising means for attaching external speakers to the acoustic frame.

21. An acoustic frame for use in connection with a flat-screen television, comprising:
an acoustic matte, said acoustic matte comprising fabric stretched over a rigid material, said acoustic matte being arranged so as to surround a display screed on the flat-screen television,
wherein said acoustic matte is substantially transparent to sound waves and substantially transparent to infra-red radiation;
an art frame removably coupled to said acoustic matte, and overlapping an outer periphery of said acoustic matte;
a ridge formed in a rear surface of said acoustic matte for positioning the acoustic frame in relation to the flat-screen television in a desired alignment and orientation; and
clips attached to a rear surface of said acoustic matter for attaching the acoustic frame to the flat-screen television.

22. An acoustic frame for use in connection with a flat-screen television, comprising:
an acoustic matte, said acoustic matte comprising fabric stretched over a rigid material, said acoustic matte being arranged so as to surround a display screed on the flat-screen television,
wherein said acoustic matte is substantially transparent to sound waves and substantially transparent to infra-red radiation;
a ridge formed in a rear surface of said acoustic matte for positioning the acoustic frame in relation to the flat-screen television in a desired alignment and orientation; and
clips attached to a rear surface of said acoustic matter for attaching the acoustic frame to the flat-screen television.
